(19) United States
(12) Patent Application Publication
(10) Pub. No.: US 2010/0061452 A1
(43) Pub. Date: Mar. 11, 2010

(54) METHOD AND APPARATUS FOR VIDEO ERROR CONCEALMENT USING HIGH LEVEL SYNTAX REFERENCE VIEWS IN MULTI-VIEW CODED VIDEO

(75) Inventors: Purvin Bibhas Pandit, Franklin Park, NJ (US); Peng Yin, West Windsor, NJ (US); Yeping Su, Camas, WA (US)

Correspondence Address: Robert D. Shedd, Patent Operations;THOMSON Licensing LLC, P.O. Box 5312, Princeton, NJ, 08543-5312, US

(73) Assignee: THOMSON LICENSING CORPORATION

(21) Appl. No.: 12/448,657

(22) PCT Filed: Jan. 4, 2008
(86) PCT No.: PCT/US2008/000102

§ 371 Date: Jun. 29, 2009

Related U.S. Application Data
(60) Provisional application No. 60/883,460, filed on Jan. 4, 2007.

(51) Int. Cl. H04N 7/12

(52) U.S. Cl. 375/240.12; 375/E07.243

(57) ABSTRACT

There are provided a method and apparatus for video error concealment using high level syntax reference views in multi-view coded video. The apparatus includes a decoder for decoding pictures for at least one view corresponding to multi-view video content from a bitstream. The pictures are representative of at least a portion of a video sequence. At least some of the pictures correspond to different time instances in the video sequence. The decoder determines whether any of the pictures corresponding to a particular one of the different time instances are lost using an existing syntax element. The existing syntax element is for indicating at least one reference view used for inter-view prediction of at least one of the pictures.

### CROSS-REFERENCE TO RELATED APPLICATIONS

This application claims the benefit of U.S. Provisional Application Ser. No. 60/883,460, filed Jan. 4, 2007, which is incorporated by reference herein in its entirety.

### TECHNICAL FIELD

The present principles relate generally to video decoding and, more particularly, to a method and apparatus for video error concealment using high level syntax reference views in multi-view coded video.

### BACKGROUND

When a picture is lost in a corrupted bitstream, several picture-based error concealment methods can be used to conceal the lost picture. In order to perform concealment, the loss of a picture and the location of the picture have to be determined.

There have been several methods to detect loss of picture in the single view case. In the International Organization for Standardization/International Electrotechnical Commission (ISO/IEC) Moving Picture Experts Group-4 (MPEG-4) Part 10 Advanced Video Coding (AVC) standard/International Telecommunication Union, Telecommunication Sector (ITU-T) H.264 recommendation (hereinafter the “MPEG-4 AVC standard”), the concept of frame_num serves the purpose of detecting loss of reference pictures. Additionally, Supplemental Enhancement Information (SEI) messages such as the recovery point SEI message, sub-sequence SEI message, recovery point SEI message, reference picture marking repetition SEI message, as well as the picture order count (POC) design, and the multiple reference picture buffering may be used for the purpose of picture loss detection.

However, such methods have not been extended for the multi-view case.

### SUMMARY

These and other drawbacks and disadvantages of the prior art are addressed by the present principles, which are directed to a method and apparatus for video error concealment using high level syntax reference views in multi-view coded video.

According to an aspect of the present principles, there is provided an apparatus. The apparatus includes a decoder for decoding pictures for at least one view corresponding to multi-view video content from a bitstream. The pictures are representative of at least a portion of a video sequence. At least some of the pictures correspond to different time instances in the video sequence. The decoder determines whether any of the pictures corresponding to a particular one of the different time instances are lost using an existing syntax element. The existing syntax element is for indicating at least one reference view used for inter-view prediction of at least one of the pictures.

According to another aspect of the present principles, there is provided a method. The method includes decoding pictures for at least one view corresponding to multi-view video content from a bitstream. The pictures are representative of at least a portion of a video sequence. At least some of the pictures correspond to different time instances in the video sequence. The decoding step includes determining whether any of the pictures corresponding to a particular one of the different time instances are lost using an existing syntax element. The existing syntax element is for indicating at least one reference view used for inter-view prediction of at least one of the pictures.

These and other aspects, features and advantages of the present principles will become apparent from the following detailed description of exemplary embodiments, which is to be read in connection with the accompanying drawings.

### BRIEF DESCRIPTION OF THE DRAWINGS

The present principles may be better understood in accordance with the following exemplary figures, in which:

FIG. 1 is a block diagram for an exemplary Multi-view Video Coding (MVC) decoder to which the present principles may be applied, in accordance with an embodiment of the present principles;

FIG. 2 is a diagram for a time-first coding structure for a multi-view video coding system with 8 views to which the present principles may be applied, in accordance with an embodiment of the present principles; and

FIG. 3 is a flow diagram for an exemplary method for decoding video data corresponding to a video sequence using error concealment for lost pictures, in accordance with an embodiment of the present principles.

### DETAILED DESCRIPTION

The present principles are directed to a method and apparatus for video error concealment using high level syntax reference views in multi-view coded video.

The present description illustrates the present principles. It will thus be appreciated that those skilled in the art will be able to devise various arrangements that, although not explicitly described or shown herein, embody the present principles and are included within its spirit and scope.

All examples and conditional language recited herein are intended for pedagogical purposes to aid the reader in understanding the present principles and the concepts contributed by the inventor(s) to furthering the art, and are to be construed as being without limitation to such specifically recited examples and conditions.

Moreover, all statements herein reciting principles, aspects, and embodiments of the present principles, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herein represent conceptual views of illustrative circuitry embodying the present principles. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (“DSP”) hardware, read-only memory (“ROM”) for storing software, random access memory (“RAM”), and non-volatile storage.

Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

In the claims hereof, any element expressed as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The present principles as defined by such claims reside in the fact that the functionalities provided by the various recited means are combined and brought together in the manner which the claims call for. It is thus regarded that any means that can provide those functionalities are equivalent to those shown herein.

Reference in the specification to “one embodiment” or “an embodiment” of the present principles means that a particular feature, structure, characteristic, and so forth described in connection with the embodiment is included in at least one embodiment of the present principles. Thus, the appearances of the phrase “in one embodiment” or “in an embodiment” appearing in various places throughout the specification are not necessarily all referring to the same embodiment.

As used herein, “high level syntax” refers to syntax present in the bitstream that resides hierarchically above the macroblock layer. For example, high level syntax, as used herein, may refer to, but is not limited to, syntax at the slice header level, the sequence parameter set (SPS) level, the picture parameter set (PPS) level, the view parameter set (VPS) level, the network abstraction layer (NAL) unit header level, and in a supplemental enhancement information (SEI) message.

For the sake of illustration and brevity, the following embodiments are described herein with respect to the use of the sequence parameter set. However, it is to be appreciated that the present principles are not limited to solely the use of the sequence parameter set with respect to the improved signaling disclosed herein and, thus, such improved signaling may be implemented with respect to at least the above-described types of high level syntaxes including, but not limited to, syntaxes at the slice header level, the sequence parameter set (SPS) level, the picture parameter set (PPS) level, the view parameter set (VPS) level, the network abstraction layer (NAL) unit header level, and in a supplemental enhancement information (SEI) message, while maintaining the spirit of the present principles.

It is to be further appreciated that while one or more embodiments of the present principles are described herein with respect to the MPEG-4 AVC standard, the present principles are not limited to solely this standard and, thus, may be utilized with respect to other video coding standards, recommendations, and extensions thereof, including extensions of the MPEG-4 AVC standard, while maintaining the spirit of the present principles.

Moreover, it is to be appreciated that the use of the term “and/or”, for example, in the case of “A and/or B”, is intended to encompass the selection of the first listed option (A), the selection of the second listed option (B), or the selection of both options (A and B). As a further example, in the case of “A, B, and/or C”, such phrasing is intended to encompass the selection of the first listed option (A), the selection of the second listed option (B), the selection of the third listed option (C), the selection of the first and the second listed options (A and B), the selection of the first and third listed options (A and C), the selection of the second and third listed options (B and C), or the selection of all three options (A and B and C). This may be extended, as readily apparent by one of ordinary skill in this and related arts, for as many items listed.

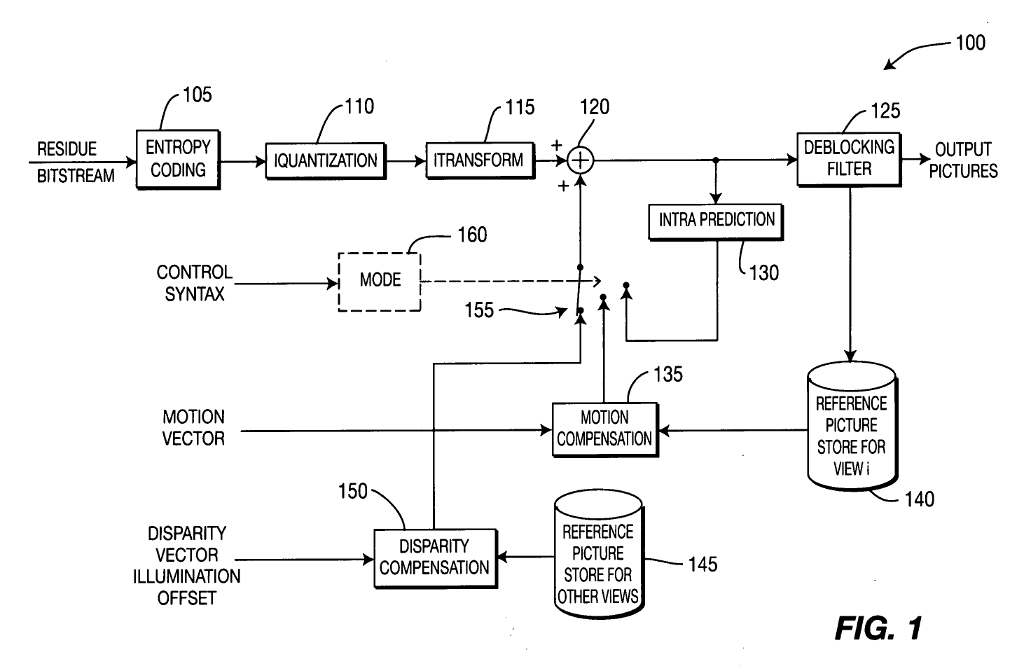

Turning to FIG. 1, an exemplary Multi-view Video Coding (MVC) decoder is indicated generally by the reference numeral 100. The decoder 100 includes an entropy decoder 105 having an output connected in signal communication with an input of an inverse quantizer 110. An output of the inverse quantizer is connected in signal communication with an input of an inverse transformer 115. An output of the inverse transformer 115 is connected in signal communication with a first non-inverting input of a combiner 120. An output of the combiner 120 is connected in signal communication with an input of a deblocking filter 125 and an input of an intra predictor 130. An output of the deblocking filter 125 is connected in signal communication with an input of a reference picture store 140 (for view i). An output of the reference picture store 140 is connected in signal communication with a first input of a motion compensator 135.

An output of a reference picture store 145 (for other views) is connected in signal communication with a first input of a disparity/illumination compensator 150.

An input of the entropy coder 105 is available as an input to the decoder 100, for receiving a residue bitstream. Moreover, an input of a mode module 160 is also available as an input to the decoder 100, for receiving control syntax to control which input is selected by the switch 155. Further, a second input of the motion compensator 135 is available as an input of the decoder 100, for receiving motion vectors. Also, a second input of the disparity/illumination compensator 150 is available as an input to the decoder 100, for receiving disparity vectors and illumination compensation syntax.

An output of a switch 155 is connected in signal communication with a second non-inverting input of the combiner 120. A first input of the switch 155 is connected in signal communication with an output of the disparity/illumination compensator 150. A second input of the switch 155 is connected in signal communication with an output of the motion compensator 135. A third input of the switch 155 is connected in signal communication with an output of the intra predictor 130. An output of the mode module 160 is connected in signal communication with the switch 155 for controlling which input is selected by the switch 155. An output of the deblocking filter 125 is available as an output of the decoder.

In accordance with the present principles, methods and apparatus are provided for video error concealment in multi-view coded video using high level syntax reference views. The present principles, at the least, address the problem of detection of picture loss in the case of multi-view coded video. Methods and apparatus are provided herein to identify/detect which pictures of a view are missing, lost, or dropped during transmission of a multi-view coded video sequence.

In an error-prone transmission environment, such as the Internet, wireless networks, and so forth, a transmitted video bitstream may suffer corruptions caused by, for example, channel impairment. A common situation encountered in some practical systems is that certain compressed video pictures are dropped from a bitstream. This is especially true for low bit-rate applications where a picture is small enough to be coded into a transmit unit, such as a real-time transport protocol (RTP) packet. At the receiver end, a robust video decoder should be able to detect such losses in order to conceal them.

In multi-view video coding (MVC), there are several views present in the coded video sequence. In the case of the current MVC extension of the MPEG-4 AVC Standard, each picture has associated with it a view identifier to identify which view to which it belongs. TABLE 1 shows the Network Abstraction Layer (NAL) unit header for the scalable video coding (SVC) multi-view video coding (MVC) extension syntax. Additionally, there are several high level syntaxes (in addition to the MPEG-4 AVC Standard syntaxes) that are present to assist in the decoding of the pictures from different views. These syntaxes are present in the Sequence Parameter Set (SPS) extension. TABLE 2 shows the sequence parameter set (SPS) in the multi-view video coding (MVC) extension of the MPEG-4 AVC Standard.

TABLE 1

| nal_unit_header_svc_mvc_extension( ) { | C | Descriptor |
|---|---|---|
| svc_mvc_flag | All | u(1) |
| if (!svc_mvc_flag) { | | |
| priority_id | All | u(6) |
| discardable_flag | All | u(1) |
| temporal_level | All | u(3) |
| dependency_id | All | u(3) |
| quality_level | All | u(2) |
| layer_base_flag | All | u(1) |
| use_base_prediction_flag | All | u(1) |
| fragmented_flag | All | u(1) |
| last_fragment_flag | All | u(1) |
| fragment_order | All | u(2) |
| reserved_zero_two_bits | All | u(2) |
| } else { | | |
| temporal_level | All | u(3) |
| view_level | All | u(3) |
| anchor_pic_flag | All | u(1) |
| view_id | All | u(10) |
| idr_flag | All | u(1) |
| reserved_zero_five_bits | All | u(5) |
| } | | |
| nalUnitHeaderBytes += 3 | | |
| } | | |

TABLE 2

| | | |
|---|---|---|
| seq_parameter_set_mvc_extension( ) { | C | Descriptor |

| | |
|---|---|
| num_views_minus_1 | ue(v) |
| for(i = 0; i <= num_views_minus_1; i++) { | |
| num_anchor_refs_I0[i] | ue(v) |
| for( j = 0; j < num_anchor_refs_I0[i]; j++ ) | |
| anchor_ref_I0[i][j] | ue(v) |
| num_anchor_refs_I1[i] | ue(v) |
| for( j = 0; j < num_anchor_refs_I1[i]; j++ ) | |
| anchor_ref_I1[i][j] | ue(v) |
| } | . |
| for(i = 0; i <= num_views_minus_1; i++) { | |
| num_non_anchor_refs_I0[i] | ue(v) |
| for( j = 0; j < num_non_anchor_refs_I0[i]; j++ ) | |
| non_anchor_ref_I0[i][j] | ue(v) |
| num_non_anchor_refs_I1[i] | ue(v) |
| for( j = 0; j < num_non_anchor_refs_I1[i]; j++ ) | |
| non_anchor_ref_I1[i][j] | ue(v) |
| } | |
| } | |

Thus, the current proposal for multi-view video coding based on the MPEG-4 AVC Standard (hereinafter “current MVC proposal for MPEG-4 AVC) includes high level syntax in the sequence parameter set (SPS) to indicate the number of coded views in the sequence. Additionally, the current MVC proposal for MPEG-4 AVC includes the inter-view references information for a view. The current MVC proposal for MPEG-4 AVC further distinguishes the dependencies of the anchor and non-anchor picture by separately sending the reference view identifiers. This is shown in TABLE 2, which includes information of which views are used as a reference for a certain view. We have recognized and propose that this information (the number of coded views) can be used in order to detect picture loss in the case of multi-view coded video.

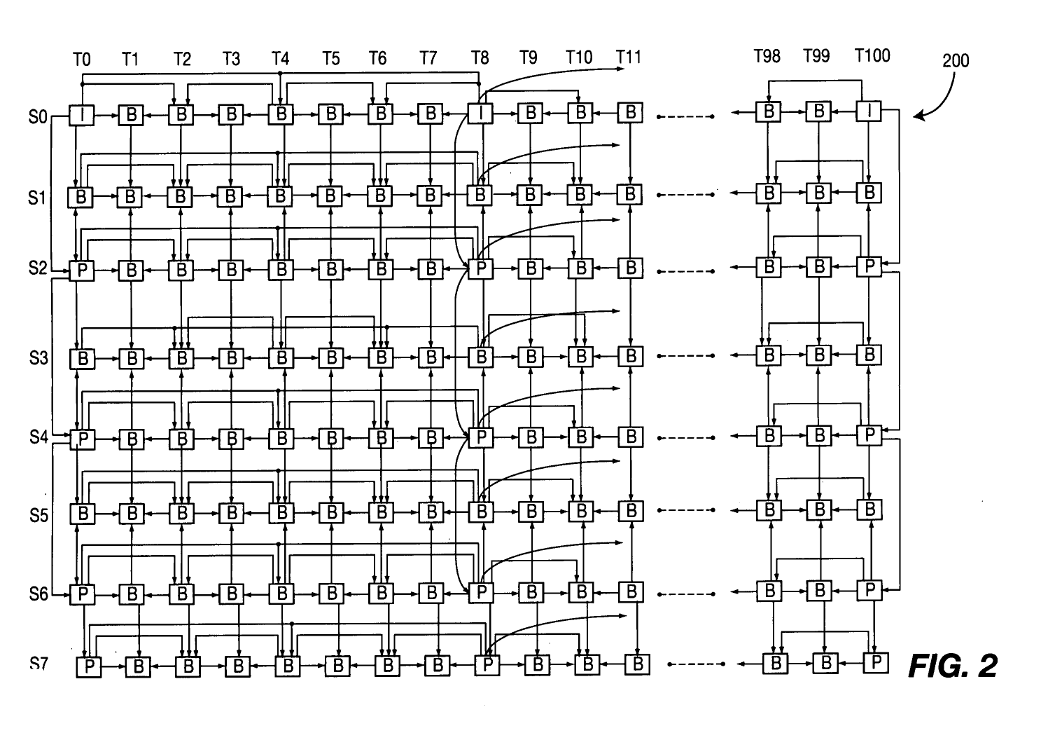

In the current multi-view video coding (MVC) extension of the MPEG-4 AVC Standard, it is mandated that pictures that belong to a certain time instant are coded first for all the views. Turning to FIG. 2, a time-first coding structure for a multi-view video coding system with 8 views is indicated generally by the reference numeral 200. In the example of FIG. 2, all pictures at the same time instance from different views are coded contiguously. Thus, all pictures (S0-S7) at time instant T0 are coded first, followed by pictures (S0-S7) at time T8, and so on. This is called time-first coding. Also, the current multi-view video coding (MVC) extension of the MPEG-4 AVC Standard includes a constraint that inter-view prediction can only be done by using pictures at that time instance. Thus, this makes it all the more relevant to detect picture loss at this time instance since the picture that is lost may be used not only as a temporal reference but also as a view reference. Thus, timely concealment of the picture is needed for the objective quality of other views.

Knowing this (time-first coding) and also the number of coded views in the sequence and the views that are needed for reference for a certain view from the sequence parameter set (SPS), we can detect the loss of a picture.

An embodiment of this detection algorithm is as follows. As mentioned above we know that pictures at the same time instance for all the views are coded first. Additionally, we know which views are needed for inter-view reference for a given view by looking at the sequence parameter set. Now, when a picture arrives for decoding, we know from the sequence parameter set syntax (view_id) which view(s) is needed for inter-view reference. Since pictures only at that time instance are needed for inter-view reference we have all the information to identify the inter-view reference picture(s). Also, before a picture can be used for decoding it should have already been decoded and placed in the decoded picture buffer (DPB).

Since we know the view_id of the reference picture and the time instance (picture order count (POC)), we can perform a search in the decoded picture buffer with the (view_id, POC) combination. If this picture is not found in the decoded picture buffer we can conclude that this picture is missing and, thus, call the appropriate concealment algorithm to conceal the lost picture before it is used as a reference.

This can be illustrated using an example below. Looking at FIG. 2, presume that the picture (S2, T4) is lost. A possible coding order for time T4 is S0, S2, S1, S4, S3, S6, S5, and S7. Since S2 is missing for this time, only S0, S1, S4, S3, S6, S5, and S7 will be received. When we receive S1, we can determine from the sequence parameter set syntax corresponding to this view that S0 and S2 at time T4 are to be used as a reference. This will be indicated by the following values for non-anchor pictures of S1:

num_non_anchor_refs_I0[i]=1

non_anchor_ref_I0[i][j]=0 (view_id of S0)

num_non_anchor_refs_I1[i]=1

non_anchor_ref_I1[i][j]=2 (view_id of S2)

Now we know that (S0, T4) and (S2, T4) are to be used as inter-view references for the current picture (S1, T4). Since the two reference pictures are required to be decoded and stored for use as reference pictures, we can perform a search in the decoded picture buffer. The current picture can be decoded correctly only if both pictures are found in the decoded picture buffer. Since picture (S2, T4) was lost, it will not be found in the decoded picture buffer and we can detect the loss of picture (S2, T4). An appropriate concealment algorithm may then be called to conceal the lost picture before decoding the current (S1, T4) picture.

The above-mentioned error detection algorithm could be applied recursively on the lost reference pictures to detect multiple picture losses.

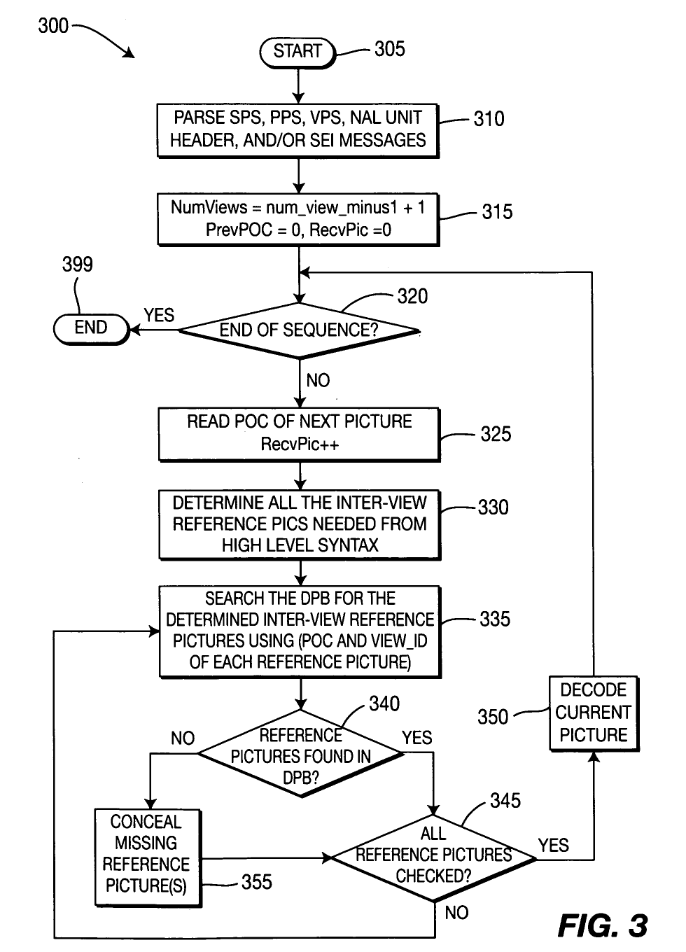

Turning to FIG. 3, an exemplary method for decoding video data corresponding to a video sequence using error concealment for lost pictures is indicated generally by the reference numeral 300.

The method 300 includes a start block 305 that passes control to a function block 310. The function block 310 parses the sequence parameter set (SPS), the picture parameter set (PPS), the view parameter set (VPS), network abstraction layer (NAL) unit headers, and/or supplemental enhancement information (SEI) messages, and passes control to a function block 315. The function block 315 sets a variable NumViews equal to a variable num_view_minus1+1, sets a variable PrevPOC equal to zero, sets a variable RecvPic equal to zero, and passes control to a decision block 320. The decision block 320 determines whether or not the end of the video sequence has been reached. If so, then control is passed to an end block 399. Otherwise, control is passed to a function block 325.

The function block 325 reads the picture order count (POC) of the next picture, increments the variable RecvPic, and passes control to a function block 330. The function block 330 determines all the inter-view reference pictures needed from a high level syntax, and passes control to a function block 335. The function block 335 searches the decoded picture buffer (DPB) for the inter-view reference pictures determined by function block 330, using the picture order count (POC) and view identifier (view_id) of each of the determined inter-view reference pictures, and passes control to a decision block 340. The decision block 340 determines whether or not the reference pictures have been found in the decoded picture buffer (DPB). If so, the control is passed to a decision block 345. Otherwise, control is passed to a function block 355.

The decision block 345 determines whether or not all reference pictures have been checked. If so, then control is passed to a function block 350. Otherwise, control is returned to the function block 335.

The function block 350 decodes the current picture and returns control to the decision block 320.

A description will now be given of some of the many attendant advantages/features of the present invention, some of which have been mentioned above. For example, one advantage/feature is an apparatus that includes a decoder for decoding pictures for at least one view corresponding to multi-view video content from a bitstream. The pictures are representative of at least a portion of a video sequence. At least some of the pictures correspond to different time instances in the video sequence. The decoder determines whether any of the pictures corresponding to a particular one of the different time instances are lost using an existing syntax element. The existing syntax element is for indicating at least one reference view used for inter-view prediction of at least one of the pictures.

Another advantage/feature is the apparatus having the decoder as described above, wherein the existing syntax element is a multi-view video coding syntax element.

Yet another advantage/feature is the apparatus having the decoder wherein the existing syntax element is a multi-view video coding syntax element as described above, wherein the multi-view video coding syntax element corresponds to an extension of the International Organization for Standardization/International Electrotechnical Commission Moving Picture Experts Group-4 Part 10 Advanced Video Coding standard/International Telecommunication Union, Telecommunication Sector H.264 recommendation.

Still another advantage/feature is the apparatus having the decoder as described above, wherein the existing syntax element is present at a high level.

Moreover, another advantage/feature is the apparatus having the decoder as described above, wherein the high level corresponds to at least at one of a slice header level, a sequence parameter set level, a picture parameter set level, a view parameter set level, a network abstraction layer unit header level, and a level corresponding to a supplemental enhancement information message.

Further, another advantage/feature is the apparatus having the decoder as described above, wherein the decoder determines whether any of the pictures corresponding to a particular one of the different time instances are lost further using time first coding information.

Also, another advantage/feature is the apparatus having the decoder that determines whether any of the pictures corresponding to a particular one of the different time instances are lost further using time first coding information as described above, wherein the decoder searches for the at least one reference picture used for the inter-view prediction of the at least one of the pictures in a previously decoded picture list. The previously decoded list represents at least a portion of the time first coding information.

Additionally, another advantage/feature is the apparatus having the decoder that searches for the at least one reference picture used for the inter-view prediction of the at least one of the pictures in a previously decoded picture list as described above, wherein the at least one reference picture to be searched for is identified using an identifier corresponding to the at least one reference picture and a particular one of the different time instances for the at least one of the pictures, the at least one of the pictures being a currently decoded picture.

These and other features and advantages of the present principles may be readily ascertained by one of ordinary skill in the pertinent art based on the teachings herein. It is to be understood that the teachings of the present principles may be implemented in various forms of hardware, software, firmware, special purpose processors, or combinations thereof.

Most preferably, the teachings of the present principles are implemented as a combination of hardware and software. Moreover, the software may be implemented as an application program tangibly embodied on a program storage unit. The application program may be uploaded to, and executed by, a machine comprising any suitable architecture. Preferably, the machine is implemented on a computer platform having hardware such as one or more central processing units (“CPU”), a random access memory (“RAM”), and input/output (“I/O”) interfaces. The computer platform may also include an operating system and microinstruction code. The various processes and functions described herein may be either part of the microinstruction code or part of the application program, or any combination thereof, which may be executed by a CPU. In addition, various other peripheral units may be connected to the computer platform such as an additional data storage unit and a printing unit.

It is to be further understood that, because some of the constituent system components and methods depicted in the accompanying drawings are preferably implemented in software, the actual connections between the system components or the process function blocks may differ depending upon the manner in which the present principles are programmed. Given the teachings herein, one of ordinary skill in the pertinent art will be able to contemplate these and similar implementations or configurations of the present principles.

Although the illustrative embodiments have been described herein with reference to the accompanying drawings, it is to be understood that the present principles is not limited to those precise embodiments, and that various changes and modifications may be effected therein by one of ordinary skill in the pertinent art without departing from the scope or spirit of the present principles. All such changes and modifications are intended to be included within the scope of the present principles as set forth in the appended claims.

1. An apparatus, comprising:
a decoder for decoding pictures for at least one view corresponding to multi-view video content from a bitstream, the pictures representative of at least a portion of a video sequence, at least some of the pictures corresponding to different time instances in the video sequence, wherein said decoder determines whether any of the pictures corresponding to a particular one of the different time instances are lost using an existing syntax element, the existing syntax element for indicating at least one reference view used for inter-view prediction of at least one of the pictures.

2. The apparatus of claim 1, wherein the existing syntax element is a multi-view video coding syntax element.

3. The apparatus of claim 2, wherein the multi-view video coding syntax element corresponds to an extension of the International Organization for Standardization/International Electrotechnical Commission Moving Picture Experts Group-4 Part 10 Advanced Video Coding standard/International Telecommunication Union, Telecommunication Sector H.264 recommendation.

4. The apparatus of claim 1, wherein the existing syntax element is present at a high level.

5. The apparatus of claim 1, wherein the high level corresponds to at least at one of a slice header level, a sequence parameter set level, a picture parameter set level, a view parameter set level, a network abstraction layer unit header level, and a level corresponding to a supplemental enhancement information message.

6. The apparatus of claim 1, wherein said decoder determines whether any of the pictures corresponding to a particular one of the different time instances are lost further using time first coding information.

7. The apparatus of claim 6, wherein said decoder searches for the at least one reference picture used for the inter-view prediction of the at least one of the pictures in a previously decoded picture list, the previously decoded list representing at least a portion of the time first coding information.

8. The apparatus of claim 7, wherein the at least one reference picture to be searched for is identified using an identifier corresponding to the at least one reference picture and a particular one of the different time instances for the at least one of the pictures, the at least one of the pictures being a currently decoded picture.

9. A method, comprising:
decoding pictures for at least one view corresponding to multi-view video content from a bitstream, the pictures representative of at least a portion of a video sequence, at least some of the pictures corresponding to different time instances in the video sequence, wherein said decoding step comprises determining whether any of the pictures corresponding to a particular one of the different time instances are lost using an existing syntax element, the existing syntax element for indicating at least one reference view used for inter-view prediction of at least one of the pictures.

10. The method of claim 9, wherein the existing syntax element is a multi-view video coding syntax element.

11. The method of claim 10, wherein the multi-view video coding syntax element corresponds to an extension of the International Organization for Standardization/International Electrotechnical Commission Moving Picture Experts Group-4 Part 10 Advanced Video Coding standard/International Telecommunication Union, Telecommunication Sector H.264 recommendation.

12. The method of claim 9, wherein the existing syntax element is present at a high level.

13. The method of claim 9, wherein the high level corresponds to at least at one of a slice header level, a sequence parameter set level, a picture parameter set level, a view parameter set level, a network abstraction layer unit header level, and a level corresponding to a supplemental enhancement information message.

14. The method of claim 9, wherein said determining step determines whether any of the pictures corresponding to a particular one of the different time instances are lost further using time first coding information.

15. The method of claim 14, wherein said determining step comprises searching for the at least one reference picture used for the inter-view prediction of the at least one of the pictures in a previously decoded picture list, the previously decoded list representing at least a portion of the time first coding information.

16. The method of claim 15, wherein the at least one reference picture to be searched for is identified using an identifier corresponding to the at least one reference picture and a particular one of the different time instances for the at least one of the pictures, the at least one of the pictures being a currently decoded picture.
